(19) United States
(12) Patent Application Publication
(10) Pub. No.: US 2002/0175064 A1
(43) Pub. Date: Nov. 28, 2002

(54) Ratcheting switch

(76) Inventors: Steven R. Hoskins, Walled Lake, MI (US); Conrad Pastwa, Orion Township, MI (US); Sheldon J. Allen, Southfield, MI (US)

Correspondence Address: BLANK ROME COMISKY & MCCAULEY, LLP, 900 17TH STREET, N.W., SUITE 1000, WASHINGTON, DC, 20006, US

(21) Appl. No.: 09/862,363

(22) Filed: May 23, 2001

(51) Int. Cl. H01H 3/02

(52) U.S. Cl. 200/529

(57) ABSTRACT

A switch and method for using the same that can be used in a variety of devices or systems. The switch has a contact carrier capable of rotating within the base of the switch. An actuator, attached to the switch base, has an end located within the center of the actuator. The end is positioned adjacent to the contact carrier. Force applied to the actuator causes the contact carrier to rotate. Because the end of the actuator is adjacent to the contact carrier, a short actuation stroke is required. A switch contact is attached above the contact carrier and further attached to a contact substrate of a device or system. The switch contact rotates in conjunction with the rotation of the contact carrier. The rotational position of the switch contact in relation to the contact substrate determines the function of the device or system attached to the switch assembly.

### BACKGROUND OF THE INVENTION

1. Field of the Invention

The present invention provides an apparatus and method for a switch mechanism. More specifically, the present invention provides a switch capable of functioning in a variety of mechanical and electrical systems.

2. Discussion of the Background

It is generally known to provide a switch for a system to allow the changing of a function of a system. Typically, the switch alternates between two states. An example of these states may be an “on” state and an “off” state in a device. The device may function after a button, for example, or the like, is actuated, by pressing of the button or other like motion. The button may be actuated again to stop the functioning of the device.

Other types of switches can include those which allow multi-function capabilities. For example, in a device having a plurality of speeds, a one-button switch may allow a user to toggle through the various speeds by repeatedly pressing the button.

Such functions can be performed by a ratcheting switch. In a ratcheting switch, a contact carrier can be connected to components of a device or system which are configured to allow the functions of the device or system to coincide with a rotational position of the contact carrier within the switch. The rotational position of a contact carrier can be determined by an actuator. The actuator provides a force towards the contact carrier, or towards a component connected to the contact carrier, to change the rotational position of the contact carrier.

However, switches that change the functions of a device or system can be unreliable. These switches may malfunction due to poor design, or may be inefficient, i.e., not changing the system when actuated. Further, the design of some switches may require a large area of the device or system, which may be undesirable and costly. Further, actuation of the switch may require a long or complicated actuation stroke. In addition, a switch may be, for example, designed to function in only one type of system, such as, a two-state alternating system, and may not be adaptable to a multi-function system.

A need, therefore, exists for a switch which provides increased reliability and/or efficiency. A further need exists for a switch which requires a minimal area of a device or system. A still further need exists for a switch which requires a minimal actuation stroke. Moreover, a need exists for a switch that may be utilized in devices or systems having a variety of functions.

### SUMMARY OF THE INVENTION

The present invention provides a ratcheting switch which may operate in a plurality of systems. The switch has a contact carrier which may rotate within a switch base, coinciding with a particular function of a system. The contact carrier is secured by a ratcheting plunger while in a neutral state. An actuator is provided that has an end adjacent to the contact carrier. Force applied by the end of the actuator toward the contact carrier causes the contact carrier to rotate. Because the end is adjacent to the contact carrier while in the neutral state, the switch requires a short actuation stroke. Further, the compact design of the ratcheting switch requires a minimal area of the device or system.

To this end, in an embodiment of the present invention, a switch is provided. The switch has a switch base. Further, the switch has an actuator attached to the switch base, the actuator having an end extending from the center of the actuator. A ratcheting plunger, having a base, is provided and is attached to the switch base. In addition, a contact carrier is provided, having a rod, and further having a plurality of edges surrounding the rod. At least one edge of the contact carrier is in contact with the base of the ratcheting plunger. Moreover, one edge of the contact carrier is in contact with an end of the actuator.

In another embodiment of the present invention, a switch is provided. The switch has a switch base. Also provided is a contact carrier which is positioned within the switch base. In addition, a ratcheting plunger is provided and is attached to the switch base. The ratcheting plunger exerts a force towards the contact carrier. Further provided is an actuator which is attached to the switch base. The actuator also exerts a force towards the contact carrier.

In still another embodiment of the present invention, a method is provided for changing functions of an apparatus. The method has a step of providing a switch base; providing an actuator attached to the switch base, the actuator having at least one end; providing a ratcheting plunger, the ratcheting plunger having a base; providing a contact carrier having a plurality of edges, the contact carrier capable of rotating; positioning the base of the ratcheting plunger adjacent to at least one edge of the contact carrier; positioning the end of the actuator adjacent to an alternate edge of the contact carrier; attaching a switch contact to the contact carrier; and attaching a contact substrate to the switch contact.

It is, therefore, an advantage of the present invention to provide an apparatus and a method for a switch that provides increased reliability.

Another advantage of the present invention is to provide an apparatus and method for a switch providing increased efficiency.

Still another advantage of the present invention is to provide an apparatus and method for a switch requiring a minimal area of a device or system.

Yet another advantage of the present invention is to provide an apparatus and method for a switch requiring a minimal actuation stroke.

Another advantage of the present invention is to provide an apparatus and method for a switch that may be utilized in devices or systems having a variety of functions.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exploded view of an embodiment of the present invention;

FIG. 2 is a perspective view of a switch contact in an embodiment of the present invention; and

FIG. 3 is a plan view of a switch base in an embodiment of the present invention.

### DETAILED DESCRIPTION OF THE PRESENTLY PREFERRED EMBODIMENTS

The present invention provides a switch and method for using the same that can be used in a variety of devices or systems. The switch has a contact carrier capable of rotating within the base of the switch. An actuator, attached to the switch base, has an end located within the center of the actuator. The end is positioned adjacent to the contact carrier. Force applied to the actuator causes the contact carrier to rotate. Because the end of the actuator is adjacent to the contact carrier, a short actuation stroke is required. A switch contact is attached above the contact carrier and further attached to a contact substrate of a device or system. The switch contact rotates in conjunction with the rotation of the contact carrier. The rotational position of the switch contact in relation to the contact substrate determines the function of the device or system attached to the switch assembly.

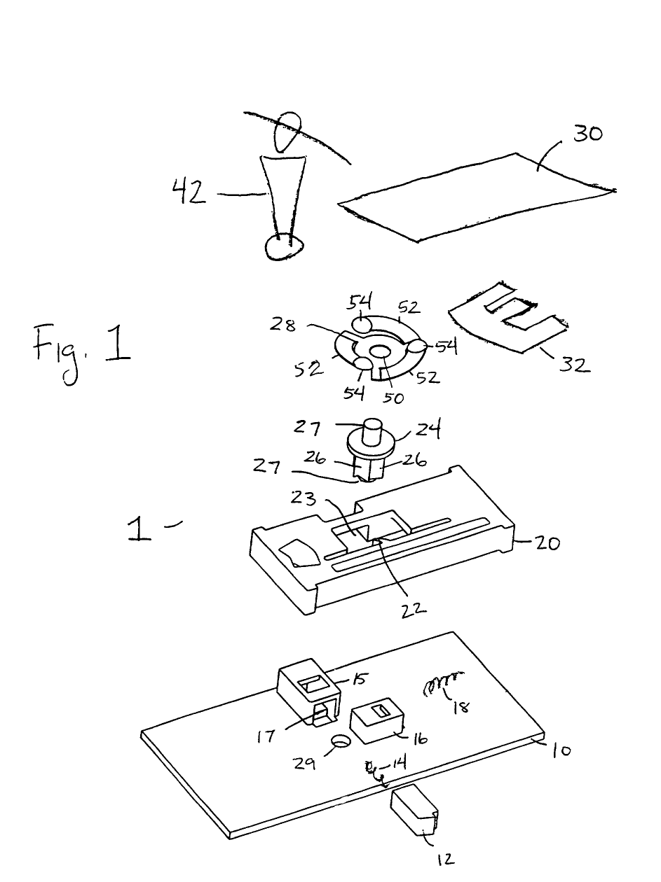

FIG. 1 illustrates an exploded view of the present invention. In an embodiment, the switch consists of a switch base 10. The switch base 10 can be sized to accommodate a particular device or system. Preferably, the switch base 10 is rectangularly shaped. However, any shape consistent with a device or system can be utilized. In addition, the switch base 10 may be constructed from plastic, metal, wood or other like material.

A ratcheting plunger 12 is incorporated into the switch base 10. The ratcheting plunger 12 may be attached to the base by adhesive, welding, or other like method via a first plunger pocket 15. The ratcheting plunger 12 can have a rectangular shape, as illustrated in FIG. 1. Or, the ratcheting plunger 12 may be shaped in any manner consistent with the design of the device or system. The ratcheting plunger 12 may be connected to a ratchet spring 14. The ratchet spring 14 can be similar to known springs. However, other types of compressible members are also contemplated in performing the function, described below, of the ratchet spring 14.

The first plunger pocket 15 may be attached to the switch base 10. The first plunger pocket 15 can be sized to house both the ratchet spring 14 and the ratcheting plunger 12. The ratchet spring 14 may also be connected to the first plunger pocket 15 within an interior 17 of the first plunger pocket 15, at an end of the ratchet spring 14 opposite to the end attached to the ratcheting plunger 12.

A second plunger pocket 16 may be preferably incorporated near the center of the switch base 10. The second plunger pocket 16 can be shaped similarly to the first plunger pocket 15. In addition, the second plunger pocket 16 can be constructed from plastic, metal, wood or other like material. The second plunger pocket 16 is attached to a return spring 18. The return spring 18 can also be similar in construction to known springs. However, other compressible members can be implemented in the switch assembly which perform the function of the return spring 18 described below.

Encasing both the first plunger pocket 15 and the second plunger pocket 16 is an actuator 20. The actuator 20 may be shaped as illustrated in FIG. 1. Or, the actuator 20 may be shaped to accommodate any specific type of device or system. In addition, the actuator can be constructed of plastic, metal, wood or other like material. The actuator 20 may have an end 22 located near the center of the actuator 20. The end 22 may preferably be within an opening 23 near the center of the actuator 20. However, other embodiments of the present invention may feature the end located at any portion of the actuator 20. The return spring 18 may be attached to the actuator 20 at the end opposite to the end attached to the second plunger pocket 16. Further, the end 22 may protrude, preferably, at an angle with the actuator 20. However, any type of angle may be utilized in forming the end 22. Moreover, the end 22 may be shaped to align with an edge 26 of a contact carrier 24. The contact carrier 24 having edges 26 may be incorporated within the actuator 20 with at least one edge 26 of the contact carrier 20 in contact with the end 22 of the actuator 20.

In addition, the contact carrier 24 can have a rod 27 around which the edges 26 are positioned. The edges 26 can be positioned parallel to the rod 27. The rod 27 may have a length greater than that of the edges 26. Further, the rod 27 may be constructed of plastic, metal, wood or other like material. The rod 27 may be positioned within an opening 29 in the switch base 10. The opening 29 is sized to receive only the rod 27. The contact carrier 24 may then be rotated within the opening 29.

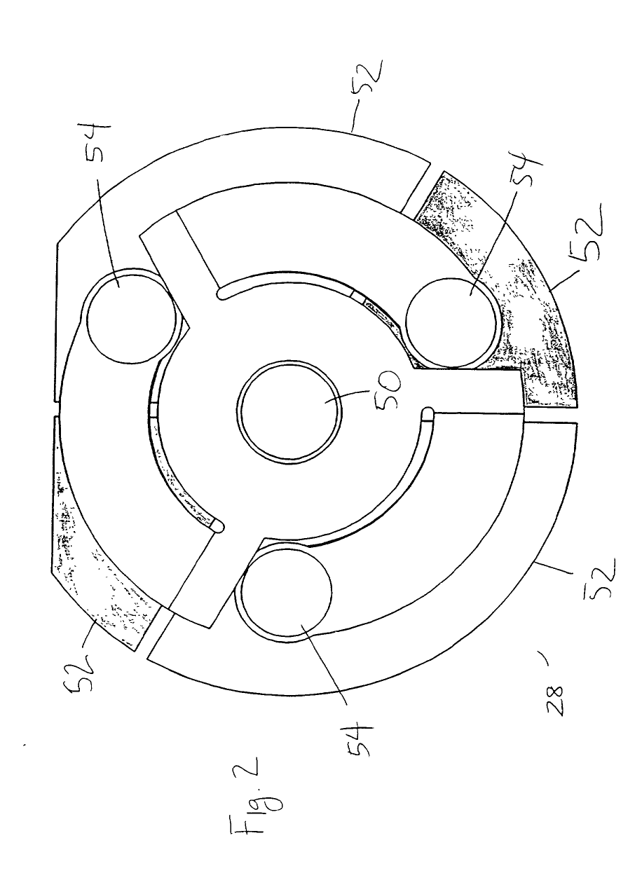

A switch contact 28 may be positioned above the contact carrier 24. The switch contact 28 is illustrated in FIG. 2. The switch contact 28 preferably has a circular shape. However, other shapes are also contemplated. The switch contact 28 has an opening 50 which may allow the switch contact 28 to be placed over an upper portion of the rod 27. The switch contact 28 may then be attached to the contact carrier 24 by adhesive, welding, or other similar method. The switch contact 28 may have arc sections 52 separated by contact points 54. In another embodiment, the switch contact 28 can be rectangularly shaped. In this embodiment, the arc sections 52 are perpendicular while still being separated by contact points 54. The switch contact 28 may be connected to a contact substrate 30 for a device or system. Moreover, the contact points 54 can include, for example, electric terminals, or the like, on the contact substrate 30. The rotational position of the arc sections 52 can then cause, for example, a circuit, to be opened or closed on the contact substrate 30, based on whether the contact points 54 are aligned with the electronic terminals on the contact substrate 30.

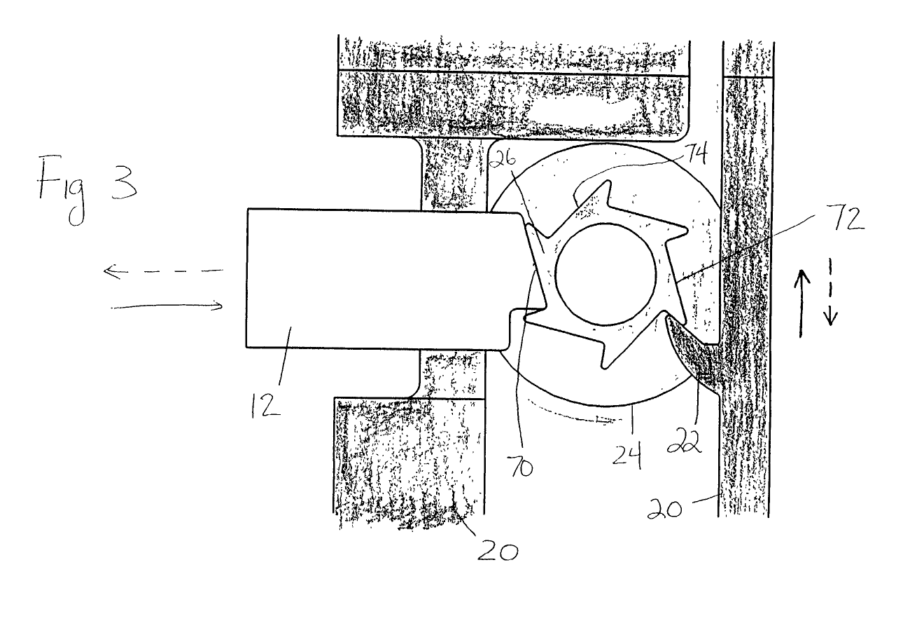

The switch assembly is a ratcheting system. FIG. 3 illustrates a cross-sectional view of the switch as can be seen through the switch base 10. An edge 26 of the contact carrier 24 is in contact with a base 70 of the ratcheting plunger 12. An alternate edge 72 of the contact carrier 24 is also in contact with the end 22 of the actuator 20.

When force is applied to the actuator 20, the end 22 pushes against the edge 72 of the contact carrier 24. Because the end 22 is adjacent to the edge 72, a short actuation stroke is required. The ratcheting plunger 12 also presses against the edge 26 of the contact carrier 24 with a certain amount of force. If the force with which the actuator 20 is moved is greater than the force applied by the ratcheting plunger 12, the contact carrier 24 will rotate. Preferably, the contact carrier 24 will rotate such that a following edge 74 will then be adjacent to the base 70 of the ratcheting plunger 12. As a result, the switch contact 28 will also rotate this amount. The contact substrate 30 which is connected to the switch contact 28 may then change functions depending on the rotational position of the switch contact 28 in relation to the contact points of the contact substrate 30.

The switch actuator 20 is moved back to a neutral position by a return force exerted by the return spring 18. The end 22 of the actuator 20 does not contact the edge 26 of the contact carrier 24 during the return to the neutral position. The alternate edge 72 of the contact carrier 24 then remains adjacent to the base 70 of the ratcheting plunger 12 until a subsequent actuation of the switch 1.

In another embodiment, the switch 1 may have an alternate contact 32 attached to the actuator 20. The alternate contact 32 can be designed in a manner similar to the contact substrate 30, having terminals or other components that allow the switch 1 to control an additional function of a device or system. For example, the contact substrate 30 may control light amplification of a device while the alternate contact 32 may control, for example, sound amplification.

In another embodiment, an external actuator 42 can be used for a multi-function device or system such as the example provided for the alternate contact 32. The external actuator 42 can be attached indirectly to the switch 1 by any other apparatus connected to the device or system. Further, the external actuator 42 can be designed to translate the switch 1 by any means of linear or cammed rotational actuation.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that all such changes and modifications be covered by the appended claims.

1. A switch assembly comprising:
a switch base;
an actuator attached to the switch base, the actuator having an end;
a ratcheting plunger attached to the switch base, the ratcheting plunger having a base; and
a contact carrier having a rod and further having a plurality of edges surrounding the rod, the contact carrier positioned within the switch base and further wherein a first edge of the plurality of edges of the contact carrier is in contact with the base of the ratcheting plunger and a second edge of the plurality of edges of the contact carrier is in contact with the end of the actuator.

2. The switch assembly of claim 1 wherein the ratcheting plunger is attached to a ratchet spring.

3. The switch assembly of claim 1 wherein the rod of the contact carrier is positioned within an opening in the switch base so as to allow the contact carrier to rotate within the opening.

4. The switch assembly of claim 1 wherein the ratchet plunger supplies a first force against the contact carrier.

5. The switch assembly of claim 4 wherein applying a second force to the actuator that is greater than the first force applied by the ratcheting plunger causes the contact carrier to rotate.

6. The switch assembly of claim 5 including a return spring attached to the actuator wherein the return spring moves the actuator to a neutral position.

7. The switch assembly of claim 6 wherein the end of the actuator does not come in contact with the edge the contact carrier while the actuator moves to the neutral position.

8. The switch assembly of claim 1 including a switch contact attached to the contact carrier.

9. The switch assembly of claim 8 wherein the switch contact is attached to a contact substrate.

10. The switch assembly of claim 1 including a switch contact attached to the contact carrier wherein a rotational position of the switch contact correlates to a change in the function of a device attached to the switch contact.

11. The switch assembly of claim 1 including an external actuator connected to the actuator.

12. The switch assembly of claim 1 including an alternate contact attached to the actuator for changing a function of a device attached to the switch assembly.

13. The switch assembly of claim 1 wherein the contact carrier rotates, said rotation causing a device connected to the switch assembly to alternate between two functional states.

14. The switch assembly of claim 1 wherein the contact carrier rotates, said rotation causing a device connected to the switch assembly to alternate between a plurality of functional states.

15. A switch assembly comprising:
a switch base
a contact carrier positioned within the switch base;
a ratcheting plunger attached to the switch base wherein the ratcheting plunger exerts a first force towards the contact carrier; and
an actuator attached to the switch base, wherein the actuator exerts a second force towards the contact carrier.

16. The switch assembly of claim 15 wherein the contact carrier is capable of rotating and further wherein the contact carrier rotates if the second force exerted by the actuator is greater than the first force exerted by the ratcheting plunger.

17. The switch assembly of claim 15 wherein the second force exerted by the actuator is exerted by an end located within the actuator.

18. The switch assembly of claim 15 wherein the second force exerted by the actuator is exerted by an end located within the center of the actuator.

19. The switch assembly of claim 15 including a switch contact attached to the contact carrier.

20. The switch assembly of claim 15 including a contact substrate attached to a switch contact wherein the switch contact is attached to the contact carrier and further wherein the rotational position of the switch contact in relation to the contact substrate determines the function of a device or system.

21. A method for changing functions of an apparatus, the method comprising the steps of:
providing a switch assembly, the switch assembly having a switch base, the switch base also having an actuator attached to the switch base, the actuator having at least one end, the switch base further having a ratchet plunger attached to the switch base, the ratchet plunger having a base, and further wherein the switch assembly has a contact carrier positioned within an opening in the switch base, the contact carrier having a plurality of edges and capable of rotating;
positioning the base of the ratchet plunger adjacent to a first edge of the plurality of edges of the contact carrier;
positioning the end of the actuator adjacent to an alternate edge of the plurality of edges of the contact carrier;
attaching a switch contact to the contact carrier;
attaching a contact substrate to the substrate to the switch contact;
applying a first force against the ratcheting plunger towards the first edge of the plurality of edges of the contact carrier;
applying a second force against the end of the actuator towards the alternate edge of the plurality of edges of the contact carrier; and
rotating the contact carrier.
